(19) United States
(12) Patent Application Publication
(10) Pub. No.: US 2015/0006835 A1
(43) Pub. Date: Jan. 1, 2015

(54) Backup Management for a Plurality of Logical Partitions

(71) Applicant: International Business Machines Corporation, Armonk, NY (US)

(72) Inventors: Martin Oberhofer, Bondorf (DE); Jens Seifert, Gaertringen (DE); Andreas Trinks, Stuttgart (DE); Andreas Uhl, Gaufelden (DE)

(73) Assignee: International Business Machines Corporation, Armonk, NY (US)

(21) Appl. No.: 14/206,438

(22) Filed: Mar. 12, 2014

(30) Foreign Application Priority Data
Jun. 27, 2013 (GB) 1311435.0

(51) Int. Cl. G06F 3/06

(52) U.S. Cl. CPC G06F 3/065; G06F 3/0604; G06F 3/0683
USPC 711/162

(57) ABSTRACT

A mechanism is provided for managing backups. A plurality of logical partitions are generated in a computer system, each logical partition having assigned a respective first portion of the main memory in the computer system as a resource and each logical partition hosting at least one application program which consumes at least a fraction of the first main memory portion of the logical partition. A second portion of the main memory is used as a global memory, the global memory not overlapping with any one of the first main memory portions. For each of the one or more of the logical partitions, one or more images of the first memory portion consumed by the at least one application program hosted by the logical partition are stored as a backup in the global memory.

### BACKGROUND

The invention relates to the field of data processing, and more particularly to the back-up of data derived from multiple logical partitions.

A growing number of companies delivering IT—services in the form of cloud services try to reduce costs for offering their services at a competitive price.

To a growing extent, virtualization technology has been employed for making better use of available server hardware resources. Said resources in particular consist of processing power, main memory and persistent storage space. For example, analytical services based on relational or columnar database systems which typically consume much main memory may be provided via a network (internet, intranet) as a service to a plurality of clients.

In a further aspect, virtualization is used for easing the management of multiple independent systems. ‘Virtualization’ refers to software and/or hardware solutions that support running multiple operating system instances on a single hardware platform, i.e., a pool of hardware resources being centrally managed. Today, there exist many virtualization solutions, e.g. IBM VM/CP, VMware ESX/ESXi, Microsoft Hyper-V and Citrix XenServer.

Current virtualization approaches are based on dividing the available resources of the underlying hardware platform into a plurality of “logical partitions”, commonly called LPARs, which are virtualized as to respectively provide as a separate ‘virtual’ computer. Said separate computer is also referred to as ‘virtual machine’ (VM). Each of said LPARs and respective VMs may host an operating system (OS). Current virtualization technology may also comprise some in-memory backup techniques for backing up data of a plurality of different virtual systems according to a centrally managed backup logic. In-memory backup approaches are advantageous in that the backups can be executed very fast due to the short access times of volatile storage, but are disadvantageous in that they consume portions of the (scarce and expensive) main memory of the LPARs, thereby competing with the memory requirements of the application programs. Two LPARs may access memory from a common memory chip, provided that the ranges of addresses directly accessible to each LPAR do not overlap. On IBM mainframes, for example, LPARs are managed by the PR/SM facility. On IBM System P Power hardware, LPARs are managed by the Power Hypervisor. The Hypervisor or PowerVM acts as a virtual switch between the LPARs and also handles the virtual SCSI traffic between LPARs.

### SUMMARY

In one illustrative embodiment, a computer implemented method is provided for managing backups. The illustrative embodiment generates a plurality of logical partitions in a computer system, each logical partition having assigned a respective first portion of a main memory in the computer system as a resource, each logical partition hosting at least one application program which consumes at least a fraction of the first main memory portion of the logical partition. The illustrative embodiment uses a second portion of the main memory as a global memory, whereby the global memory does not overlap with any one of the first main memory portions. For each of the one or more of the LPARs, the illustrative embodiment stores one or more images of the first memory portion consumed by the at least one application program hosted by the logical partition as a backup in the global memory.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

In the following FIGS. 2-6, embodiments of the invention will be described in greater detail by way of example, whereby reference to the drawings will be made in which:

FIG. 1 shows a state of the art server system;

FIG. 2 shows a block diagram of a computer system comprising multiple LPARs according to one embodiment;

FIG. 3 shows the main memory of the system of FIG. 2 and the sub-portions of said main memory in greater detail;

FIG. 4 shows a multi-tiered storage management system;

FIG. 5 shows a plurality of images stored in different tiers of the multi-tiered storage management system; and

FIG. 6 shows a flow chart of a method of creating backup images in a computer system comprising multiple LPARs.

### DETAILED DESCRIPTION

It is an objective of embodiments of the invention to provide for an improved computer implemented method, computer-readable medium and computer system for creating data back-ups in a computer system being based on a plurality of LPARs. Said objective is solved by the features of the independent claims. Preferred embodiments are given in the dependent claims. If not explicitly indicated otherwise, embodiments of the invention can be freely combined with each other.

The term ‘backup’ as used herein is a copy of some data, e.g. application data and/or user data, which is created by means of an in-memory backup technology. For example, said backup technology may be a snapshot-based backup technology based e.g. on a copy-on-write or re-direct-on-write approach.

An ‘image’ of a particular main memory space as used herein is a piece of data being a derivative of the data content of said main memory space and comprising all necessary information for allowing the restoring of the totality of data being stored in said main memory space. The term ‘image’ should not be considered to be limited to the creation of a physical copy of each memory block in the backuped main memory space. According to some embodiments, the image may be created based on said physical copies, but according to other embodiments, the image may be based on pointers to modified and/or unmodified portions of the backuped main memory space. Preferentially, said image is stored in association with a time stamp being indicative of the creation time of said image. In dependence on the kind of data being stored in the memory portion from which the image was created, the image may comprise computer-interpretable instructions of an application program loaded into said memory portion and/or may comprise payload data (i.e., non-executable data) or a combination thereof. For example, the instructions may have the form of bytecode and/or of a source code file written in a scripting language and loaded into the memory. Preferentially, the backuped data relates to a functionally coherent set of data consisting e.g. of computer-interpretable instructions of an application program, e.g. a database management system, and some payload-data processed by said application program, e.g. the data content of a database and/or some index structures having been generated from said data content.

An ‘application program’ as used herein is a software program comprising computer-executable instructions. Examples of an application program are relational (e.g. MySQL, PostgreSQL) or columnar database management systems (e.g. Vertica, Sybase IQ), e-Commerce application programs, ERP systems, CMS systems or the like.

A ‘non-volatile computer-readable storage medium’, ‘non-volatile storage medium’ or simply ‘storage medium’ as used herein is any kind of storage medium operable to permanently store computer-interpretable data. ‘Permanent storage’ as used herein can retain the stored data even when not powered. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The term ‘memory’ as used herein relates to any kind of volatile storage medium acting or potentially acting as the main memory of a computer system or one of its hosted VMs. ‘Main memory’ is directly or indirectly connected to a central processing unit via a memory bus. A memory may be, for example, but not limited to, a random access memory (RAM), e.g. a dynamic RAM (DRAM) or a static RAM (SRAM), e.g. a DDR SDRAM.

A ‘storage tier’ as used herein is a group of volatile and/or non-volatile storage resources that match a predefined set of capabilities, such as, for example, minimum I/O response time.

A ‘logical partition’ (LPAR) as used herein is a subset of a computer system's hardware resources which are organized, by means of some virtualization hardware and/or software, as a virtual machine that is operable to act as a separate computer. An LPAR may host its own operating system and one or more application programs which are separated from the operating systems and application programs of other LPARs being based on other subsets of said computer system's hardware resources.

A ‘resource’ as used herein is any hardware component of a computer system which is assigned to or is assignable to one of said computer system's LPARs. A resource may be, for example, one or more CPUs, some memory blocks of a memory, some persistent storage space, network capacities, or the like.

A ‘global memory’ as used herein is a section of the main memory which can be accessed and used by each one of a plurality of LPARs of a computer system for storing data and/or that is managed by a central management component responsible for storing data derived from the plurality of the LPARs of the system. Said data being stored in said global memory may comprise backups.

A ‘virtual system’ or ‘virtual machine’ is a simulated computer system whose underlying hardware is based on a logical partition of a hardware platform. Multiple logical partitions of said hardware platform constitute the basis for a corresponding number of virtual systems.

A ‘plug-in’ is a piece of software code that enables an application or program to do something it couldn't by itself.

In one aspect, the invention relates to a computer implemented method for managing backups. The method comprises: providing a computer system having a main memory; providing a plurality of logical partitions of the computer system, each logical partition having assigned a respective first portion of the main memory as a resource, each logical partition hosting at least one application which consumes at least a fraction of the first main memory portion of said logical partition; using a second portion of the main memory as a global memory, whereby the global memory does not overlap with any one of the first main memory portions; for each of the one or more of the LPARs, storing one or more images of the first memory portion consumed by the at least one application hosted by said logical partition as a backup in the global memory.

The providing of the LPARs may comprise, for example, the creation of said LPARs by virtualization software. Assigning a first portion of the main memory as a resource to a particular LPAR means that said first portion acts as the main memory of the virtual system hosted by said LPAR and that the size of said first portion defines the size of the main memory of said virtual system.

Said features may be advantageous for multiple reasons: in state of the art systems, in-memory backups of application data of a particular virtual system/LPAR are stored in the main memory of said LPAR. Therefore, the backups ‘compete’ with the application programs for memory space and may decrease the performance of said application data e.g. by forcing the virtual system of said LPAR to swap the data once the main memory assigned to said LPAR is used to its capacity. By storing the backup images in a separate, global memory, the fraction of the main memory assigned to a particular LPAR is not consumed by any backup data, thereby leaving more memory space for the application data.

In a further beneficial aspect, the available main memory of the underlying hardware platform is used more effectively by ‘pooling’ the backups of multiple LPARS in a single, centrally managed section of the main memory. Administrators of current cloud service environments being based on multiple LPARs/virtual systems have no prediction when an individual backup space of an application program of an LPAR is running full or when the total sum of available main memory will be exhausted. The size of a backup of an application program is currently not exactly predictable as said size may depend on the data requested by a client of a cloud service for being processed and loaded into the main memories of the different virtual systems hosted by the LPARs. Therefore, in state of the art systems, the size of the main memory portions assigned to the individual LPARs was usually chosen larger than actually needed for providing some ‘contingency buffer’ in respect to the available memory. By pooling the backups of multiple LPARs in a single global memory the size differences of the backup images will ‘average out’ and smaller portions of the available main memory may be assigned to the individual LPARs safely.

According to embodiments the at least one application program is a database management program. The backup comprises one or more indices of a database of said database management program. Alternatively, or in addition, the backup comprises at least one read optimized store of said database and/or at least one write optimized store of said database. An in-memory, write-optimized store (WOS) of a DBMS, for example, stores, in a row-wise fashion, data that is not yet written to disk. Thus, a WOS acts as a cache for the database. A read-optimized store (ROS) of a DBMS comprises one or more ROS containers. A ROS container stores one or more columns for a set of rows in a special format, e.g. a columnar format or “grouped ROS” format. The storing of data in a ROS may comprise the application of computationally demanding data compression algorithms. For example, in relational in-memory databases such as SolidDB, an in-memory copy is created from some non-volatile disk based data and instructions. The in-memory database is used as a cache between a client and said non-volatile disk based data and instructions.

Said features may be advantageous as the creation of the above mentioned stores and data structures are complex and require a considerable amount of time and computational power. Thus, creating backups of said data structures increases the speed of restoring said complex data structures in case of a system failure or other use case scenario where a quick restoring of the complete in-memory database is required.

According to embodiments each of the one or more images is created by means of a memory snapshot technique. The snapshot technique may be, for example, copy-on-write, split-mirror, or redirect-on-write. Using a snap-shot technique in the context of an LPAR-based virtualization platform may be advantageous as it is possible to use highly advanced and efficient in-memory backup technology without having to reserve a predefined portion of the main memory of an individual LPAR for the snapshots. Rather, images of multiple LPARs are stored to the global memory.

According to embodiments each of the one or more images created for any one of the LPARs is an image of the complete first memory portion assigned to said one LPAR. Said feature may be advantageous as it allows restoring the data content of a main memory portion of each LPAR, which may comprise an arbitrary number of executed application programs and their respective payload data, as it was at a particular moment in time, with no additional overhead for managing the backups of the application programs individually. According to other embodiments, the image creation and storage is managed in an application-specific manner.

According to embodiments the method further comprises, at the runtime of the application programs of the LPARs, dynamically re-allocating memory elements of the global memory and/or of some first memory portions and/or of an unassigned memory portion of the main memory for modifying the size of the global memory. For example, memory elements previously assigned to one of the first memory portions or hitherto unassigned memory elements may be assigned to the global memory for increasing the size of the global memory. Said features may be advantageous as they allow to dynamically modify the size of the global memory being used or usable for backing up data of all the LPARs. This re-assignment may enable a virtualization software or any other form of central management logic to dynamically modify the fraction of the totally available memory used for backup-purposes in dependence on some dynamically determined factors such as backup space required by individual application programs or LPARs, service level agreements of a client or the like. In addition, or alternatively, the method may further comprise dynamically, at the runtime of the application programs of the logical partitions, re-allocating memory elements of one or more of the first memory portions and/or of the global memory and/or of an unassigned memory portion of the main memory for modifying the sizes of the first memory portions. For example, memory elements may be de-allocated from the global memory and may be allocated to one of the LPARs whose first memory portion is almost used to its capacity for increasing the size of said first memory portion. The re-allocation is managed for each first memory portion of the LPARs individually. Thus, backup space in the global memory may be increased at the cost of the first memory portions and vice versa. Said features may enable a virtualization software or any other form of central management logic to dynamically modify the sizes of the main memories of the individual LPARs used for executing application programs in dependence on some dynamically determined factors such as required backup space, the number of currently unassigned memory blocks, service level agreements of a client or the like. In state of the art systems it was not possible to increase or decrease the main memories of different LPARs in dependence on the required memory space of the hosted application programs. To the contrary, the above mentioned embodiments allow to flexibly adapt the size(s) of the main memories of each one of the LPARs in dependence on dynamically determined conditions, thereby using the available main memory more effectively. Depending on the hardware platform underlying the plurality of LPARs, said memory elements may be, for example, pages or memory blocks.

According to embodiments the method further comprises, for each one of the one or more logical partitions: monitoring the sizes of each image created for the one or more application programs hosted by said at least one logical partition and automatically predicting, based on results of the monitoring, the memory size required by the one or more application programs of the at least one logical partition in the future. The monitored data may be stored, for example, in a history file accessible by an analytical module. The analytical module may be part of an optimized snapshot module which may be part of a virtualization software or which may be a standalone application program. In addition, the method comprises: executing the re-allocating of the memory elements for modifying the size of the first memory portion of the at least one logical partition in dependence on the predicted memory size of the one or more application programs hosted by said LPAR. For example, in case predicted required memory space exceeds the current size of said first memory portion, the size of said first memory portion is increased. In case the predicted required memory space is so small that the amount of unused memory of said first memory portion exceeds a threshold value, the size of said first memory portion is decreased. The threshold may be specified in a configuration file and may depend on a service level agreement between a service provider operating the virtual systems and a client using one of the application programs via a network. In addition or alternatively the method may comprise executing the re-allocating of the memory elements for modifying the size of the global memory in dependence on the predicted memory size. In addition or alternatively, the method may comprise executing the modification of the size of the sub-portions of the global memory in dependence on the monitored image sizes. Said features may be advantageous as they allow to reliably predict the required memory space of the application programs hosted by the individual LPARs and to adapt the memory space assigned to the LPARs accordingly. This is achieved by monitoring the sizes of the backup images and re-allocating memory elements to and from the first memory portions of the respective LPARs. Thus, the sizes of the main memories of the LPARs may be flexibly adapted in dependence on the predicted memory requirements of the application programs. Further, said features allow prioritizing memory needs of the application programs higher than the memory needs of the backup processes, e.g. by de-assigning memory elements from the global memory and assigning said memory elements to the first memory portion of one of the LPARs.

According to embodiments, the method of any one of the above embodiments is executed by a module which may be referred to as ‘smart snapshot optimizer’. The module may be a plug-in of an operating system or of virtualization software running on a server system constituting the hardware platform of the multitude of LPARs. Alternatively, the method may be executed by a module being an integral element of an operating system of the server system.

According to embodiments the computer system acting as the hardware platform of the plurality of LPARs is a server system. At least some of the logical partitions host a respective virtual system. The method further comprises: Accessing program routines of an operating system of the server system, whereby the default function of said program routines is the de-allocation and/or allocation of memory elements of the main memory to and from the LPARs. Said program functions make use of memory virtualization functions supported by the hardware of the computer system. The method further comprises using said program routines for the dynamic de-allocation and/or re-allocation of memory elements of the global memory for modifying the size of the global memory and/or using said program routines for the dynamic de-allocation and/or re-allocation of memory elements to and from the first portions of the main memory for modifying the sizes of the individual first memory portions. This may be advantageous as the re-use of hardware functions already present in many server architectures used for virtualization facilitates the implementation of the advanced backup management method and also increases the performance of memory reallocation as hardware functions tend to be faster than software-based functions.

According to embodiments the method comprises automatically determining, based on results of the monitoring, that the memory consumption of one of the application programs hosted by a respective one of the LPARs exceeds or will exceed the size of the first memory portion of said LPAR or exceeds the total size of the main memory available in the hardware platform; outputting an alert; and/or automatically allocating further memory elements of the global memory or of unassigned memory elements of the main memory to said first memory portion. In case the predicted required memory space is so small that the amount of unused memory of said first memory portion exceeds a threshold value, the size of said first memory portion may be decreased automatically by de-assigning memory elements.

Thus, said features may ensure that the system automatically assigns additional memory elements to any of the LPARs if needed, thereby avoiding swapping and out-of-memory errors, and/or allows an operator of the system to buy additional memory space in time.

For example, an image of an application program may have been determined to have a size of 300 MB. The current size of the first memory portion of the LPAR hosting said application program may be 1 GB. The applied prediction algorithm may estimate that the 300 MB of the (space-efficiently organized) back-up image correspond to about 950 MB memory actually required by the application program at runtime. The prediction logic may comprise a minimum threshold of 100 MB unoccupied memory space per LPAR. In case that threshold is exceeded (as the case here), a warning message is emitted or a corrective action is automatically executed. Thus, as in the example there are only about 50 MB unoccupied memory in said first memory portion, a warning may be issued indicating that said particular LPAR needs more memory and/or an automated assignment of additional memory elements to said LPAR running out of memory may be executed.

According to embodiments the method further comprises: reserving LPAR-specific sub-portions of the global memory for the one or more images of each of the logical partitions, wherein the one or more images of each of the one or more logical partitions are selectively stored in the respectively reserved sub-portion.

According to embodiments the method may further comprise dynamically, at the runtime of the application programs of the logical partitions, modifying the sizes of the sub-portions of the global memory in dependence on the results of the monitoring. The modification of the size of the individual sub-portions may be based on re-allocating memory elements of one or more of the other sub-portions and/or of an unassigned memory portion of the main memory and/or of memory elements currently assigned to the first memory portions. The modification of the sizes of the sub-portions of the global memory may also be implemented by any other means of data organization, e.g. by means of file directories, the grouping of pointers identifying snapshot images, and the like. Said features may enable virtualization software or any other form of central management logic to dynamically modify the sizes of the sub-portions. Thus, contrary to state-of-the-art snapshot techniques which are based on snapshot image containers of constant, invariable sizes, said embodiments may allow to use available memory space more effectively.

According to embodiments, the method further comprises providing a multi-tier storage management system which is operatively coupled to the computer system. The storage management system uses the global memory as a first storage tier. The storage management system comprises at least one further storage tier, wherein in the at least one storage tier (and in any other storage tier of the storage management system) each sub-portion of the global memory corresponds to a respective sub-portion of each of said storage tiers; the storage management system creates one or more copies of the one or more images stored in the sub-portions of the global memory and stores the one or more copies in respective sub-portions of the one or more further storage tiers. A sub-portion may correspond to a logical or physical partition or a separate file directory or merely to management logic being operable to manage pointers to the images stored in the individual storage tiers on a per-application or a per-source-LPAR basis. Said features may be advantageous as at least some of the images may be persisted not only in the volatile RAM but also in each of n storage tiers of the storage management system, n being any number larger than 1, whereby the second and each further storage tier typically consist of non-volatile storage which is cheap and more abundantly available. For example, every second image of a particular application program of an LPAR may be persisted in a non-volatile storage of the second storage tier and every 10th one of said copies may again be copied to a third storage tier. This ensures that the in-memory data can be recovered in case of a power outage and that at least some of the backup-images can be stored on a cheap storage type such as DVDs or tape drives for long term storage. In a further beneficial aspect, the improved snapshot and image management is seamlessly integrated in existing multi-tier storage management system.

According to embodiments the method further comprises evaluating one or more configuration files and executing the creation of the copies and/or the storing of the copies in the one or more further storage tiers in accordance with said configuration files. The configuration files may comprise, for example, conditions and thresholds of rules used for predicting, based on an image size, if the corresponding application program needs more memory than available in the corresponding LPAR. The configuration may comprise service level agreements specifying how often a backup image should be created and in which type of storage/storage tier said backup should be persisted. The configuration may be editable via a graphical user interface. This may increase the flexibility and adaptability of the backup management.

According to embodiments the method further comprises: For at least one of the logical partitions, automatically reading one of the or more images stored in the corresponding sub-portion of the global memory, wherein in case no image is contained in said sub-portion, an image stored in a corresponding sub-portion of one of the further storage tiers of the storage management system is read; restoring the at least one application of said at least one logical partition from the read image. Said features may allow a fully automated recovery of in-memory application program data e.g. in case of a system failure.

According to further embodiments, the method comprises monitoring the time period required for writing a copy of one of the images of the at least one application programs to a non-volatile storage medium; and prohibiting the automated creation and storing of a further image of said application program in the global memory until at least the monitored time period has lapsed between a first moment of storing the image preceding said further image in the global memory and a second moment of storing said further image in the global memory. The non-volatile storage medium may be, for example, part of a further storage tier of a multi-tier storage management system. Said features may be advantageous, as even if due to a service level agreement (SLA) or due to any other configuration or program logic the next snapshot image would be due for being taken, said snapshot is not created as that does not make sense if the previous snapshot has not been written to the persistent storage. Thus, by automatically prohibiting the creation of the further snapshot image which cannot be flushed immediately, the blocking of CPU and storage resources is prohibited.

According to some embodiments, the method further comprises receiving configuration data for creating the images dynamically, e.g. by reading a configuration file which may comprise LPAR-specific SLAs; if, according to said configuration, a particular one of the application programs running on one of the LPARs shall be de-provisioned, dynamically de-assigning memory elements from the LPAR hosting said application program. The compliance of the size of the memory portion assigned to said LPAR may be continuously monitored and compared with the SLAs specified in the configuration and with the current memory consumption of the application program (which may be determined based on the size of the most recent image of that application program). The size of said memory portion assigned to said LPAR and/or the size of the global memory used for backup purposes and/or the number of images stored in the global memory for that particular application program may be continuously adapted to ensure compliance with the SLAs. For example, an SLA may specify how many images of a particular application program should be stored in the global memory and the minimal time intervals for creating the images. In case of a multi-tier storage architecture, the SLA may specify the number of images to be stored in each of said storage tiers.

In a further aspect, the invention relates to a computer-readable medium comprising computer-readable program code embodied therewith. When executed by a processor, said program code causes the processor to execute a method according to anyone of the embodiments described previously.

In a further aspect the invention relates to a computer system comprising a main memory, one or more processors and a plurality of logical partitions. The main memory comprises a global memory. Each logical partition has assigned a respective first portion of the main memory as a resource. Each logical partition has assigned one or more of the processors as a resource. Each logical partition hosts at least one application which consumes at least a fraction of the first main memory portion of said logical partition. The computer system further comprises a management module which is adapted for assigning, upon creation of each of the plurality of logical partitions, a portion of the main memory as the first portion to said logical portion. The management module uses a second portion of the main memory as the global memory, whereby the global memory does not overlap with any one of the first main memory portions. For each of the one or more of the logical partitions, the management module stores one or more images of the first memory portion consumed by the at least one application hosted by said logical partition as a backup in the global memory.

According to embodiments the computer system further comprises a multi-tier storage management system which is operatively coupled to the management module. The storage management system is adapted to use the global memory as a first storage tier. The storage management system comprises one or more additional storage tiers, wherein each sub-portion of the global memory corresponds to a respective sub-portion of each of said one or more additional storage tiers. The management module in interoperation with the storage management system is adapted for creating one or more copies of the one or more images stored in the global memory; and storing the one or more copies in respective application program specific or LPAR specific sub-portions of the one or more additional storage tiers.

The total available main memory of the hardware platform may be based on one or more hardware modules which are collectively managed by the virtualization software.

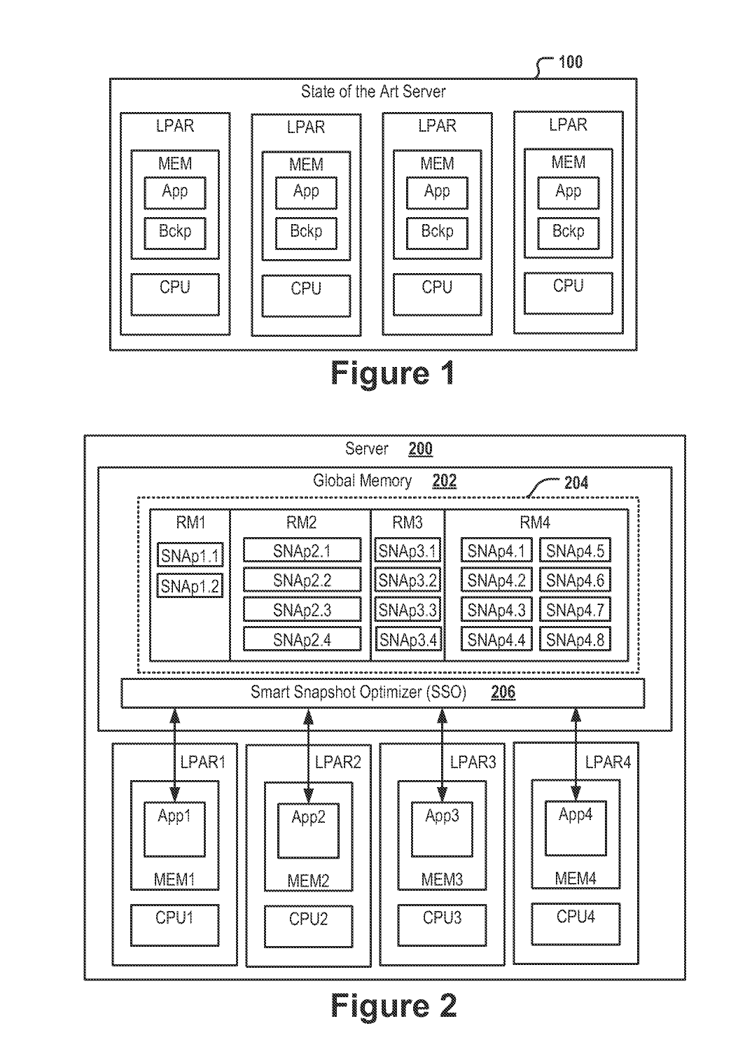

FIG. 1 shows a state-of-the-art server computer system 100 as commonly used by current cloud service providers. The hardware resources of the single server computer system are divided into multiple logical partitions (LPARs) where each LPAR has one or more dedicated CPUs and a DRAM (MEM) resource whose size may be specified upon the creation of the respective LPAR. On each LPAR, an operating system is running which is able to host any application program. There is a DRAM area App in the memory portion MEM assigned to each LPAR. Said memory area App comprises the data of a particular application program (executables and/or payload data). Within each memory portion MEM, there is also an area for the in-memory backup identified as Bckp for storing backups of a respective application in said LPAR. Using memory backup techniques in a state of the art system as shown in FIG. 1 thus requires a reserved memory area Bckp in the memory assigned to a particular LPAR for storing the backups of each application hosted by said LPAR. In this architecture, it is not possible to adapt the size of the memory assigned to a particular LPAR in dependence on the actual requirements of said LPAR's application program or to dynamically prioritize memory App for running an application over memory Bckp for storing backups of said application. Thus, the available memory resources are not managed effectively. Administrators have to choose the memory space MEM of each LPAR as large as possible to prevent out-of-memory exceptions and swapping, although at least some of the applications/LPARs may actually require more memory space than others and the memory requirements of the different LPARs may vary dynamically.

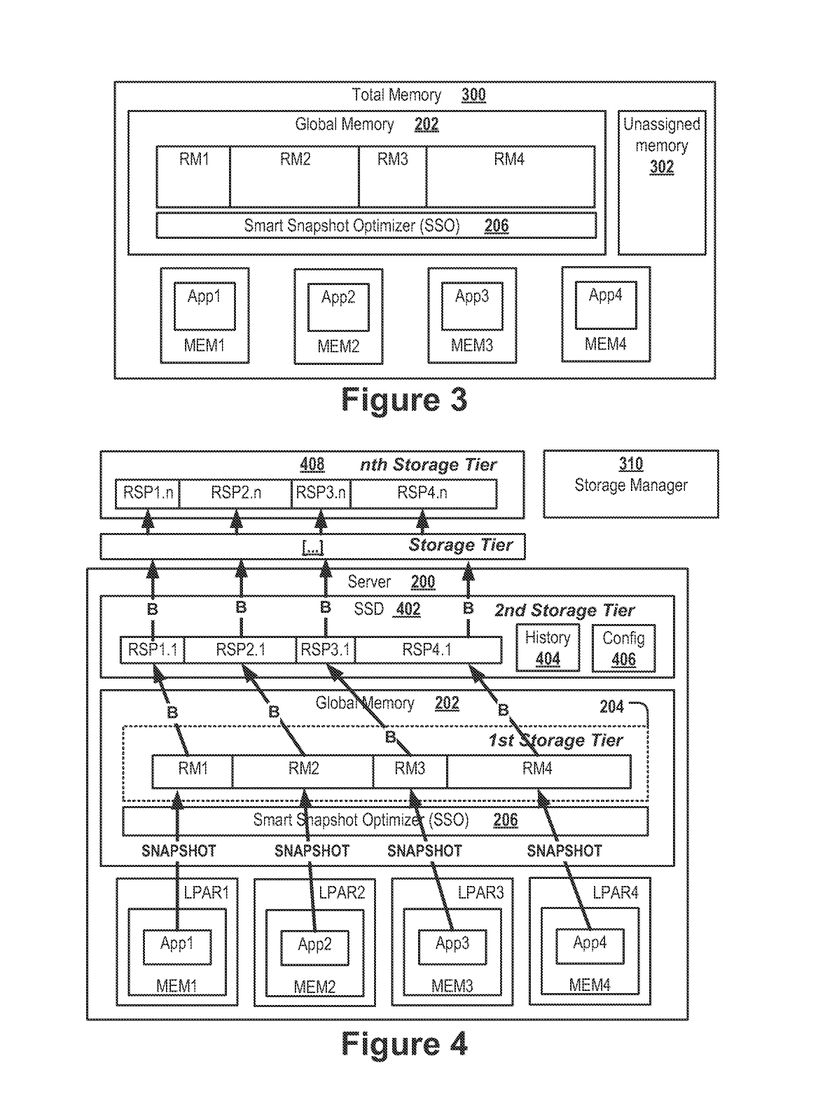

FIG. 2 shows a block diagram of a computer system 200 acting as a platform for providing a plurality of logical partitions LPAR1-LPAR4. Compared to the system depicted in FIG. 1, the system depicted in FIG. 2 may make more effective use of the available main memory. The computer system comprises one or more memory modules which together constitute a total main memory 300 (not shown here but shown in detail in FIG. 3). The total memory 300 comprises a global memory 202 which again may comprise the first storage tier 204 used for storing some in-memory backup images SNAP1.1-SNAP4.8. In addition, the global memory may comprise a program module 206 referred to as ‘smart snapshot optimizer’ which may be implemented, for example, as a plug-in or integral part of the operation system of the server 200. Each one of the LPARs has assigned one or more processing units (CPU1-CPU4) and a respective portion MEM1-MEM4 of the totally available memory 300. Each memory portion assigned to one of the LPARs acts as the main memory of the virtual system hosted by said LPAR and may comprise one or more applications App 1, . . . , App4, for example database management systems, columnar or relational database tables or analytical software tools operating on data and index structures stored in said tables. The smart snapshot analyzer is operable to monitor the sizes of the backup-images which are stored in the global memory 202 and may also monitor the time required for storing a copy of some of said images to a non-volatile storage tier. The smart snapshot optimizer may automatically reassign memory elements to and from the global memory and the individual memory portions MEM1-MEM4 of the LPARs for dynamically adapting the size of the global memory (which can be used for backup purposes) and the size of the memory portions of the individual LPARs (which is used for running individual applications, for providing said applications as a service in a cloud service environments to one or more clients, etc.) in dependence on a plurality of factors. That factors may be a service level agreement made with a client currently requesting one of the application programs a service. Likewise, said factors may consist of any other kind of configuration data, may correspond to a predicted future memory consumption of an application program, to the amount of unassigned memory elements available and any combination thereof. The arrows of FIG. 2 indicate that the smart snapshot optimizer is operable to monitor the size of the images and the process of creating the images and is also able to delay the creation of an image of an application program if the previous image has not yet been fully flushed to a persistent storage.

FIG. 3 depicts the functional components of the totality of the memory 300 available in a given hardware platform 200 in greater detail. A plurality of first portions MEM1-MEM4 of the main memory 300 is assigned to respective LPARs for acting as a main memory of the virtual systems hosted by said LPARs. Each one of said first memory portions is used for running one or more application programs, but not for backup purposes. A second portion 202 of the main memory 300 constitutes the global memory 202 which may comprise a plurality of images taken from the application programs and may comprise a program module 206 for making better use of the available memory resources when creating backups for multiple LPARs in a virtualized environment. Each LPAR corresponds to a respectively reserved memory portion RM1-RM4 within the global memory 202. All images created for the one or more applications hosted by a particular LPAR are stored in the memory portion in the global memory reserved for said LPAR. For example, the images created for LPAR3 are stored in the respectively reserved memory portion RM3 of the global memory. Further, memory 300 may also comprise unassigned memory 302 that is available to be assigned to other portions of main memory 300.

FIG. 4 shows a multi-tier storage management system wherein the global memory 202 of the server computer system 200 comprises or constitutes the first storage tier 204. Images are created by means of a snapshot technology from each of the applications App1-App4 currently loaded into the first memory portions MEM1-MEM4 of the LPARs. The creation of the images and the storing of the images in the respectively reserved portions of the global memory may be executed under the control of the smart snapshot optimizer 206. At least some of the images may be copied in accordance with some configuration data to a 2nd storage tier 402 consisting of non-volatile storage (e.g. SSD). The 2nd storage tier may also comprise respectively reserved storage portions RSP1.1-RSP4.1 for storing the image copies of the different LPARs separately. The ‘reservation’ may be implemented by means of a file directory structure or by any other technology which helps organizing stored data in a groupwise manner. The storage management system may comprise additional storage tiers up to an nth storage tier 408. At least some of the image copies are copied and stored in the next-lower tier of the storage hierarchy. Said storage cascade along the multiple storage tiers may be managed by a storage manager 310 such as, for example, the Tivoli storage manager. Typically, the lower a storage tier in the hierarchy, the cheaper the underlying storage type and the larger the size of the available storage capacity. The cascading of the image copies down the storage hierarchy and also the restoring of in-memory application data from the images or image copies may be executed in accordance with SLAs and corresponding rules.

2nd storage tier 402 may also comprise some history data 404 being indicative of the time, date or other context information (user ID of the client, applicable SLA, number of clients concurrently requesting a service) of creating and/or storing anyone of the images. In particular, the history data 404 may be being indicative of the size of that image and the time for flushing a corresponding image-copy to non-volatile storage. The history data 404 may be created by the smart snapshot optimizer 206. The smart snapshot optimizer 206 may also be operable to access some configuration 406 which may comprise some SLAs specifying how much memory space shall be assigned for backup purposes (global memory) or production purposes (LPAR specific memory) for a particular client, LPAR and/or application program.

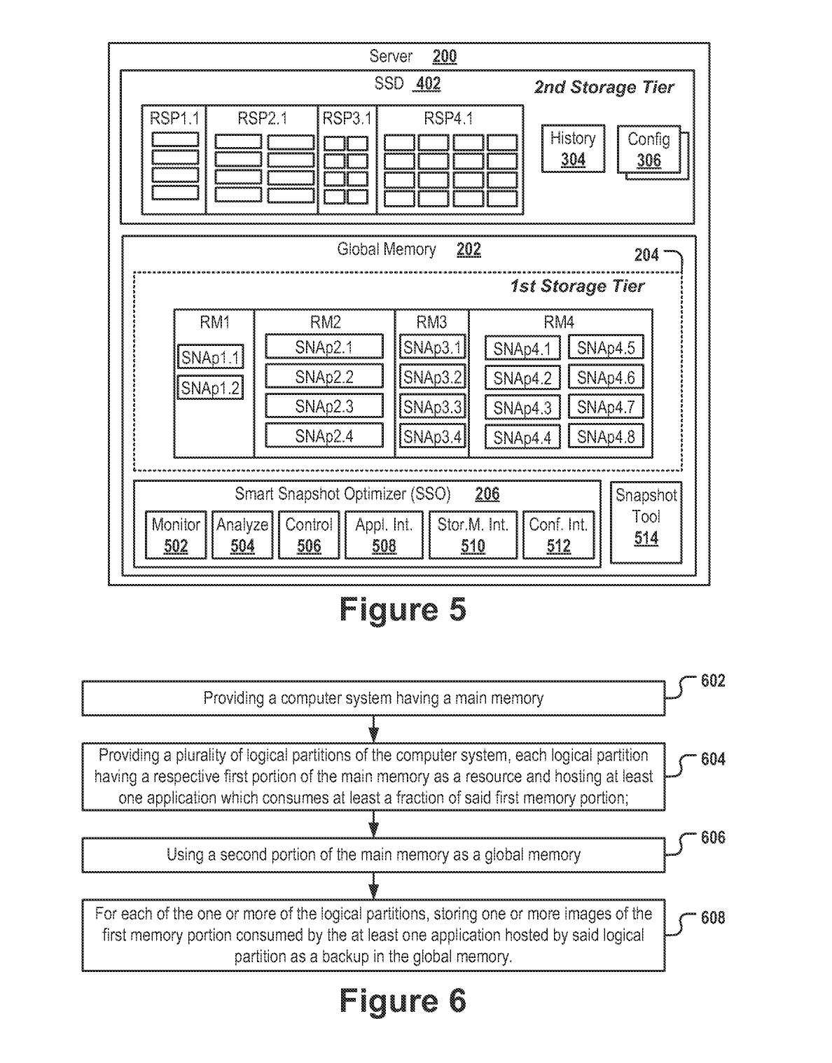

FIG. 5 shows the first and 2nd storage tier of the server system 200 of FIGS. 2-4 in greater detail. The first storage tier 204 of the global memory 202 may comprise in its memory portion RM1 reserved for image data of LPAR1 two images SNAP1.1 and SNAP1.2. It may not be possible to store a greater number of images due to a SLA that assigns only a very limited memory space for backup purposes to the application hosted in LPAR1. There is also not much memory space RM3 reserved for backing up application data hosted by LPAR3, but due to the smaller size of the application program App3 hosted by LPAR3 compared to the application data of App1 hosted by LPAR1, 4 images of App3 can be stored in the memory portion RM3 of the global memory. The images may be taken automatically by a snapshot tool on a regular basis, e.g. in accordance with a SLA. A comparatively large memory portion RM2 of the global memory has been reserved for LPAR2 and comprises 4 comparatively large images SNAP2.1-SNAP2.4. The memory portion RM4 has been reserved for LPAR4 and comprises 8 images SNAP4.1-SNAP4.8 of application App4 hosted by LPAR4.

The 2nd storage tier 402 or any other non-volatile storage may comprise some history data 304 being indicative of the time, date or other context information (user ID of the client, applicable SLA, number of clients concurrently requesting a service) of creating and/or storing anyone of the images. In particular, the history data 304 may be being indicative of the size of that image and the time for flushing a corresponding image-copy to non-volatile storage. The history data 304 may be created by the monitoring module 502 of the smart snapshot optimizer 206. The analyzer module 504 of the optimizer 206 may use the history data for predicting the size of any image to be created for any one of the application programs at a particular moment in time and/or for a particular client and may also predict the memory space consumed by the corresponding application program at runtime at that future moment in time. The optimizer 206 may be operable to access some configuration 306, via configuration interface 512, which may comprise some SLAs specifying how much memory space shall be assigned for backup purposes (global memory) or production purposes (LPAR specific memory) for a particular client, LPAR and/or application program. The control module 506 of the optimizer 206 may trigger the execution of hardware functions for reassigning memory elements in order to dynamically increase or decrease the fraction of the available memory assigned to a particular one of the LPARs. The optimizer may be interoperable with a snapshot tool 514 which may create the images based on a snapshot technology. The smart snapshot optimizer 206 may comprise an interface 510 for interoperating with a storage manager 310 for coordinating if and when a particular image should be created from anyone of the applications and for creating and storing image copies in the different storage tiers. For example, the optimizer 206 receives from the storage manager a notification when a copy of a particular image has been flushed to the 2nd, non-volatile storage tier and will prohibit the snapshot tool 514 from creating a further image of that application program before that notification was received. The application interface 508 may allow the smart snapshot optimizer to interoperate with the individual application programs which shall be backuped. For example, the interface 508 may be used to send a message to said application program which triggers the application program to complete or gracefully terminate all ongoing transactions and to implement a lock to ensure data consistency throughout the backup-process.

Thus, the smart snapshot optimizer is operable to centrally manage the backup creation across all LPARs provided by the server computer system 200. Said module may be responsible for initially partitioning the global memory and each one of the memory portions of the LPARs. The initial partitioning may be executed in accordance with a configuration (see configuration 306 of FIG. 5) which may comprise some service level agreements (SLAs). Said SLAs may also comprise some data being indicative of the priority of different LPARs in respect to their memory requirements. For example, in case two LPARs run out of memory and only a small amount of unassigned memory may be available, said small amount of memory may be automatically assigned to the LPAR of the higher priority. Thus, the automated and SLA-conform memory management in a virtualized system is facilitated. Depending on the backup technology applied, the backup images may consist of full backups and/or incremental backups. The monitoring unit 502 in combination with the analyzing unit 504 of the smart snapshot optimizer may allow predicting future memory shortages of individual LPARs and to automatically (re-allocation of memory elements) and/or semi-automatically (alarm messages to an operator) take a corrective action. The prediction may be executed in dependence on the time and date, the type of the application program backups, the applicable SLAs, the identity of the client or the like. Thus, the TCO for the cloud service provider and the work time of the administrator is reduced and the efficiency of memory usage is increased.

FIG. 6 shows a flowchart of a method which may provide for an improved and more effective management of available memory resources in a virtualized hardware platform 200. At first, a computer system 200 constituting the hardware platform and having a total amount of main memory 300 is provided in step 602. In step 604, a plurality of logical partitions of said computer system is provided, whereby each logical partition LPAR1-LPAR4 has assigned a respective first portion MEM1-MEM4 of the main memory as a resource. Each LPAR hosts at least one application which consumes at least a fraction of the first memory portion assigned to the LPAR hosting said application. In step 606, a 2nd portion of the main memory is used as a global memory, which may imply that all backup images of all LPARs are pooled in a single logical volume. In step 608, for each of the one or more logical partitions LPAR1-LPAR4, one or more images of the first memory portion consumed by the at least one application hosted by said LPAR are stored as a backup in the global memory 202.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing has been with reference to particular embodiments of the invention, it will be appreciated by those skilled in the art that changes in these embodiments may be made without departing from the principles and spirit of the invention, the scope of which is defined by the appended claims.

1. A computer implemented method for managing backups, the method comprising:
generating a plurality of logical partitions in a computer system, each logical partition having assigned a respective first portion of a main memory in the computer system as a resource, each logical partition hosting at least one application program which consumes at least a fraction of the first main memory portion of the logical partition;
using a second portion of the main memory as a global memory, the global memory not overlapping with any one of the first main memory portions; and
for each of the one or more of the logical partitions, storing one or more images of the first memory portion consumed by the at least one application program hosted by the logical partition as a backup in the global memory.

2. The computer implemented method of claim 1, wherein the at least one application program is a database management program, wherein the backup comprises at least one element being selected from a group comprising:
one or more indices of a database of the database management program;
at least one read optimized store of the database management program; or
at least one write optimized store of the database management program.

3. The computer implemented method of claim 1, wherein each of the one or more images is created by means of a memory snapshot technique, the snapshot technique being one of: copy-on-write; split-mirror, or redirect-on-write.

4. The computer implemented method of claim 1, wherein each of the one or more images created for any one of the plurality of logical partitions is an image of the complete first memory portion assigned to the one logical partition.

5. The computer implemented method of claim 1, further comprising:
dynamically, at the runtime of the application programs of the plurality of logical partitions, re-allocating memory elements of the global memory and of the first memory portions or of an unassigned memory portion of the main memory for modifying a size of the global memory;
dynamically, at the runtime of the application programs of the plurality of logical partitions, re-allocating memory elements of one or more of the first memory portions and of the first memory portions or of the unassigned memory portion of the main memory for modifying sizes of the first memory portions;
dynamically, at the runtime of the application programs of the plurality of logical partitions, modifying sizes of sub-portions of the global memory, each sub-portion being used for selectively storing images of a respective one of the plurality of logical partitions.

6. The computer implemented method of claim 5, further comprising:
for at least one logical partition of the plurality of logical partitions:
monitoring sizes of each image created for the at least one application program hosted by the at least one logical partition; and
automatically predicting, based on results of the monitoring, the memory size required by the at least one application program of the at least one logical partition in the future; and
executing the re-allocating of the memory elements for modifying at least the size of the first memory portions of the at least one logical partition in dependence on the predicted memory size;
executing the re-allocating of the memory elements for modifying the size of the global memory in dependence on the predicted memory size; or
executing the modification of the sizes of the sub-portions of the global memory in dependence on the monitored image sizes.

7. The computer implemented method of claim 5, wherein the computer system is a server system, wherein at least one of the plurality of logical partitions host a respective virtual system, the method further comprising:
accessing program routines of an operating system of the server system, whereby the default function of the program routines is the dynamic de-allocation or allocation of memory elements of the main memory to and from the plurality of logical partitions, the program routines functions making use of memory virtualization functions supported by hardware of the computer system; and
using the program routines for the dynamic de-allocation or re-allocation of memory elements to and from the global memory for modifying the size of the global memory; or
using the program routines for the dynamic de-allocation or re-allocation of memory elements to and from the first portions of the main memory for modifying the sizes of the individual first memory portions.

8. The computer implemented method of claim 6, further comprising:
automatically determining, based on results of the monitoring, that the memory consumption of the at least one application of the at least one logical partition exceeds or will exceed the size of the first memory portion of the at least one logical partition;
outputting an alert in response to the memory consumption of the at least one application of the at least one logical partition exceeding or preparing to exceed the size of the first memory portion of the at least one logical partition; and
automatically allocating memory elements of other first memory portions or unassigned memory elements of the main memory to the first memory portion.

9. The computer implemented method of claim 6, further comprising:
automatically determining, based on results of the monitoring, that the memory consumption of one of the application programs hosted by a respective one of the plurality of logical partitions exceeds the size of the first memory portion of the logical partition or exceeds the total size of the main memory;
outputting an alert in response to the memory consumption of one of the application programs hosted by a respective one of the plurality of logical partitions exceeding the size of the first memory portion of the logical partition or exceeding the total size of the main memory; and
automatically allocating further memory elements of the global memory or of unassigned memory elements of the main memory to the first memory portion.

10. The computer implemented method of claim 5, further comprising:
reserving LPAR-specific sub-portions of the global memory for the one or more images of each of the plurality of logical partitions, wherein the one or more images of each of the plurality of logical partitions are selectively stored in a respectively reserved sub-portion;
providing a multi-tier storage management system being operatively coupled to the computer system, wherein the multi-tier storage management system uses the global memory as a first storage tier, wherein the multi-tier storage management system comprises at least one additional storage tier, wherein each sub-portion of the global memory corresponds to a respective sub-portion of each storage tier of the multi-tier storage management system;
the storage management system creating one or more copies of the one or more images stored in the sub-portions of the global memory; and
the storage management system storing the one or more copies of the one or more images in the respective sub-portions of each storage tier of the multi-tier storage management system.

11. The computer implemented method of claim 10, further comprising:
evaluating one or more configuration files; and
executing the creation of the one or more copies of the one or more images and the storing of the copies in each storage tier of the multi-tier storage management system in accordance with the one or more configuration files.

12. The computer implemented method of claim 11, further comprising:
monitoring a time period required for writing a copy of one of the one or more images by the at least one application program to a non-volatile storage medium; and
prohibiting the creation and storing of a further image of the application program in the global memory until at least the monitored time period has lapsed between a first moment of storing the image preceding the further image in the global memory and a second moment of storing the further image in the global memory.

13. A computer program product comprising a computer readable storage medium having a computer-readable program stored therein, wherein the computer-readable program, when executed on a computing device, causes the computing device to:
generating a plurality of logical partitions in the computing device, each logical partition having assigned a respective first portion of a main memory in the computing device as a resource, each logical partition hosting at least one application program which consumes at least a fraction of the first main memory portion of the logical partition;
use a second portion of the main memory as a global memory, the global memory not overlapping with any one of the first main memory portions; and
for each of the one or more of the logical partitions, storing one or more images of the first memory portion consumed by the at least one application program hosted by the logical partition as a backup in the global memory.

14. A computer system comprising:
one or more processors; and
a main memory comprising a global memory, wherein the main memory comprises instructions which, when executed by the one or more processors, causes the one or more processors to:
generate a plurality of logical partitions in the computer system, each logical partition having assigned a respective first portion of the main memory as a resource, each logical partition having assigned one or more of the one or more processors as a resource, each logical partition hosting at least one application program which consumes at least a fraction of the first main memory portion of the logical partition;
use a second portion of the main memory as the global memory, the global memory not overlapping with any one of the first main memory portions; and
for each of the one or more of the logical partitions, store one or more images of the first memory portion consumed by the at least one application program hosted by the logical partition as a backup in the global memory.

15. The computer system of claim 19 wherein the instructions further cause the one or more processors to:
use the global memory as a first storage tier of a multi-tier storage management system operatively coupled to the computer system, wherein the multi-tier storage management system comprises at least one additional storage tier, wherein the one or more images are stored in the global memory in LPAR-specific sub-portions, and wherein each sub-portion of the global memory corresponds to a respective sub-portion of each store tier of the multi-tier storage management system;
create one or more copies of the one or more images stored in the sub-portions of the global memory; and
store the one or more copies of the one or more images in the respective sub-portions of each storage tier of the multi-tier storage management system.

16. The computer program product of claim 13, wherein the computer readable program further causes the computing device to:
dynamically, at the runtime of the application programs of the plurality of logical partitions, re-allocate memory elements of the global memory and of the first memory portions or of an unassigned memory portion of the main memory for modifying a size of the global memory;
dynamically, at the runtime of the application programs of the plurality of logical partitions, re-allocate memory elements of one or more of the first memory portions and of the first memory portions or of the unassigned memory portion of the main memory for modifying sizes of the first memory portions; or
dynamically, at the runtime of the application programs of the plurality of logical partitions, modify sizes of sub-portions of the global memory, each sub-portion being used for selectively storing images of a respective one of the plurality of logical partitions.

17. The computer program product of claim 16, wherein the computer readable program further causes the computing device to:
for at least one logical partition of the plurality of logical partitions:
monitor sizes of each image created for the at least one application program hosted by the at least one logical partition; and
automatically predict, based on results of the monitoring, the memory size required by the at least one application program of the at least one logical partition in the future; and
execute the re-allocating of the memory elements for modifying at least the size of the first memory portions of the at least one logical partition in dependence on the predicted memory size;
execute the re-allocating of the memory elements for modifying the size of the global memory in dependence on the predicted memory size; or
execute the modification of the sizes of the sub-portions of the global memory in dependence on the monitored image sizes.

18. The computer program product of claim 16, wherein the computer readable program further causes the computing device to:
use the global memory as a first storage tier of a multi-tier storage management system operatively coupled to the computer system, wherein the multi-tier storage management system comprises at least one additional storage tier, wherein the one or more images are stored in the global memory in LPAR-specific sub-portions, and
wherein each sub-portion of the global memory corresponds to a respective sub-portion of each storage tier of the multi-tier storage management system;
create one or more copies of the one or more images stored in the sub-portions of the global memory; and
store the one or more copies of the one or more images in the respective sub-portions of each storage tier of the multi-tier storage management system.

19. The computer system of claim 14, wherein the instructions further cause the one or more processors to:
dynamically, at the runtime of the application programs of the plurality of logical partitions, re-allocate memory elements of the global memory and of the first memory portions or of an unassigned memory portion of the main memory for modifying a size of the global memory;
dynamically, at the runtime of the application programs of the plurality of logical partitions, re-allocate memory elements of one or more of the first memory portions and of the first memory portions or of the unassigned memory portion of the main memory for modifying sizes of the first memory portions; or
dynamically, at the runtime of the application programs of the plurality of logical partitions, modify sizes of sub-portions of the global memory, each sub-portion being used for selectively storing images of a respective one of the plurality of logical partitions.

20. The computer system of claim 19, wherein the instructions further cause the one or more processors to:
for at least one logical partition of the plurality of logical partitions:
monitor sizes of each image created for the at least one application program hosted by the at least one logical partition; and
automatically predict, based on results of the monitoring, the memory size required by the at least one application program of the at least one logical partition in the future; and
execute the re-allocating of the memory elements for modifying at least the size of the first memory portions of the at least one logical partition in dependence on the predicted memory size;
execute the re-allocating of the memory elements for modifying the size of the global memory in dependence on the predicted memory size; or
execute the modification of the sizes of the sub-portions of the global memory in dependence on the monitored image sizes.
